(19) United States
(12) Patent Application Publication
(10) Pub. No.: US 2016/0293079 A1
(43) Pub. Date: Oct. 6, 2016

(54) DISPLAY DEVICE

(71) Applicant: SAMSUNG DISPLAY CO., LTD., Yongin-si (KR)

(72) Inventors: Ji-Sun Kim, Seoul (KR); Jae-Keun Lim, Suwon-si (KR); Chong-Chul Chai, Seoul (KR)

(21) Appl. No.: 14/882,215

(22) Filed: Oct. 13, 2015

(30) Foreign Application Priority Data
Mar. 31, 2015 (KR) 10-2015-0044990

(51) Int. Cl. G09G 3/20

(52) U.S. Cl. CPC G09G 3/20; G09G 2300/0426; G09G 2310/0202; G09G 2310/0272; G09G 2310/08; G09G 2330/021; G09G 2330/027

(57) ABSTRACT

A display device includes: a display panel divided into a first area and a second area; a first scan driver to provide a scan signal to a pixel in the first area through a first scan line coupled to the pixel in the first area; a second scan driver to provide the scan signal to a pixel in the second area through a second scan line coupled to the pixel in the second area; a first scan switching transistor and a second scan switching transistor to couple the first scan line to the second scan line based on the scan signal, the first scan switching transistor and the second scan switching transistor being arranged between the first area and the second area; a data driver to provide data signals; and a timing controller to control the first and second scan drivers and the data driver.

### CROSS-REFERENCE TO RELATED APPLICATION

This application claims priority to and the benefit of Korean Patent Application No. 10-2015-0044990, filed on Mar. 31, 2015 in the Korean Intellectual Property Office (KIPO), the content of which is incorporated herein in its entirety by reference.

### BACKGROUND

1. Field

One or more aspects of example embodiments relate generally to a display device. More particularly, one or more aspects of example embodiments of the present inventive concept relate to a data compensating device, and a display device having the same.

2. Description of the Related Art

Flat panel display (FPD) devices are widely used as display devices of electronic devices, because FPD devices are relatively lightweight and thin compared to cathode-ray tube (CRT) display devices. Examples of FPD devices include liquid crystal display (LCD) devices, field emission display (FED) devices, plasma display panel (PDP) devices, and organic light emitting display (OLED) devices. The OLED devices have been spotlighted as next-generation display devices, because the OLED devices have a wide viewing angle, a rapid response speed, a thin thickness, low power consumption, etc.

As an electric device that includes the display device has various functions, a partial driving method that displays an image on a partial area or region of a display panel may be used. For example, a mobile phone that includes a curved display device may include a function that displays an image on a curved area.

The above information disclosed in this Background section is only for enhancement of understanding of the background of the invention and therefore it may contain information that does not form prior art.

### SUMMARY

Some example embodiments provide a display device capable of decreasing power consumption when the display device is driven in a partial mode.

According to one or more example embodiments, a display device includes: a display panel including a plurality of pixels, the display panel being divided into a first area and a second area; a first scan driver configured to provide a scan signal to a pixel from among the pixels arranged in the first area through a first scan line coupled to the pixel in the first area; a second scan driver configured to provide the scan signal to a pixel from among the pixels arranged in the second area through a second scan line coupled to the pixel in the second area; a first scan switching transistor and a second scan switching transistor configured to couple the first scan line to the second scan line based on the scan signal, the first scan switching transistor and the second scan switching transistor being arranged between the first area and the second area; a data driver configured to provide data signals to the pixels in the first area and the second area through data lines coupled to the pixels in the first area and the second area; and a timing controller configured to generate control signals to control the first scan driver, the second scan driver, and the data driver.

In an example embodiment, the first scan switching transistor may be configured to turn on in response to the scan signal provided from the first scan driver, and the second scan switching transistor may be configured to turn off when an image is displayed on only the first area (e.g., when an image is displayed on the first area, but not on the second area).

In an example embodiment, the second scan switching transistor may be configured to turn on in response to the scan signal provided from the second scan driver, and the first scan switching transistor may be configured to turn off when an image is displayed on only the second area (e.g., when an image is displayed on the second area, but not on the first area).

In an example embodiment, the first scan line and the second scan line may be coupled to each other when the first scan switching transistor and the second scan switching transistor are turned on in response to the scan signal provided from the first scan driver and the second scan driver when an image is displayed on the first area and the second area.

In an example embodiment, the first scan driver may be arranged at one side of the display panel, and the second scan driver may be arranged at another side of the display panel.

In an example embodiment, the first scan switching transistor may include: a first terminal coupled to the first scan line; a second terminal coupled to the second switching transistor; and a gate terminal coupled to the first terminal.

In an example embodiment, the second scan switching transistor may include: a first terminal coupled to the second scan line; a second terminal coupled to the first scan switching transistor; and a gate terminal coupled to the first terminal.

In an example embodiment, the first scan switching transistor and the second switching transistor may include a P-channel Metal Oxide Semiconductor (PMOS).

In an example embodiment, the first scan switching transistor and the second switching transistor may include an N-channel Metal Oxide Semiconductor (NMOS).

In an example embodiment, the display device may further include: a first emission controller configured to provide an emission control signal to the pixel in the first area through a first emission control line coupled to the pixel in the first area; a second emission controller configured to provide the emission control signal to the pixel in the second area through a second emission control line coupled to the pixel in the second area; and a first emission switching transistor and a second emission switching transistor configured to couple the first emission control line to the second emission control line based on the emission control signal, the first emission switching transistor and the second emission switching transistor being arranged between the first area and the second area.

In an example embodiment, the first emission switching transistor may include: a first terminal coupled to the first emission control line; a second terminal coupled to the second emission switching transistor; and a gate terminal coupled to the first terminal.

In an example embodiment, the second emission switching transistor may include: a first terminal coupled to the second emission line; a second terminal coupled to the first emission switching transistor; and a gate terminal coupled to the first terminal.

According to one or more example embodiments, a display device include: a display panel including a plurality of pixels, the display panel being divided into a first area and a second area; a first scan driver configured to provide a scan signal to a pixel from among the pixels arranged in the first area through a first scan line coupled to the pixel in the first area; a second scan driver configured to provide the scan signal to a pixel from among the pixels arranged in the second area through a second scan line coupled to the pixel in the second area; a scan switching transistor configured to couple the first scan line to the second scan line, the scan switching transistor being arranged between the first scan line and the second scan line; a scan switching controller configured to generate a scan switching signal to control the scan switching transistor; a data driver configured to provide data signals to the pixels in the first area and the second area through data lines coupled to the pixels in the first area and the second area; and a timing controller configured to generate control signals to control the first scan driver, the second scan driver, and the data driver.

In an example embodiment, the scan switching transistor may be configured to turn off in response to the scan switching signal when an image is displayed on only the first area (e.g., when an image is displayed on the first area, but not on the second area).

In an example embodiment, the scan switching transistor may be configured to turn off in response to the scan switching signal when an image is displayed on only the second area (e.g., when an image is displayed on the second area, but not on the first area).

In an example embodiment, the first scan line and the second scan line may be coupled to each other when the scan switching transistor is turned on in response to the scan switching signal when an image is displayed on the first area and the second area.

In an example embodiment, the first scan driver may be arranged at one side of the display panel, and the second scan driver may be arranged at another side of the display panel.

In an example embodiment, the display device may further include: a first emission controller configured to provide an emission control signal to the pixel in the first area through a first emission control line coupled to the pixel in the first area; a second emission controller configured to provide the emission control signal to the pixel in the second area through a second emission control line coupled to the pixel in the second area; an emission switching transistor configured to couple the first emission control line to the second emission control line, the emission switching transistor being arranged between the first area and the second area; and an emission switching controller configured to generate an emission switching signal to control the emission switching transistor.

In an example embodiment, the emission switching transistor may be configured to turn off in response to the emission switching signal when an image is displayed on only the first area or only the second area (e.g., when an image is displayed on one of the first area and the second area, but not on another one of the first area and the second area).

In an example embodiment, the emission switching transistor may be configured to turn on in response to the emission switching signal when an image is displayed on the first area and the second area.

Therefore, a display device according to one or more example embodiments may selectively provide a scan signal to a first area of a display panel and/or a second area of the display panel by connecting or disconnecting first scan lines disposed in the first area and second scan lines disposed in the second area. Thus, power consumption of the display device may decrease.

### BRIEF DESCRIPTION OF THE DRAWINGS

Illustrative, non-limiting example embodiments will be more clearly understood from the following detailed description taken in conjunction with the accompanying drawings.

FIG. 1 is a block diagram illustrating a display device according to some example embodiments.

FIG. 2 is a diagram illustrating an example embodiment of a pixel included in a display panel of the display device of FIG. 1.

FIG. 3 is a diagram illustrating a display panel included in the display device of FIG. 1.

FIGS. 4A and 4B are diagrams illustrating an operation of the display device of FIG. 1.

FIG. 5 is a block diagram illustrating a display device according to some example embodiments.

FIG. 6 is a diagram illustrating a display panel included in the display device of FIG. 5.

FIGS. 7A and 7B are diagrams illustrating an operation of the display device of FIG. 5.

FIG. 8 is a block diagram illustrating an electronic device that includes the display device of FIG. 1 or FIG. 5.

FIG. 9 is a diagram illustrating an example embodiment in which the electronic device FIG. 8 is implemented as a smart phone.

### DETAILED DESCRIPTION

Hereinafter, the present inventive concept will be explained in more detail with reference to the accompanying drawings.

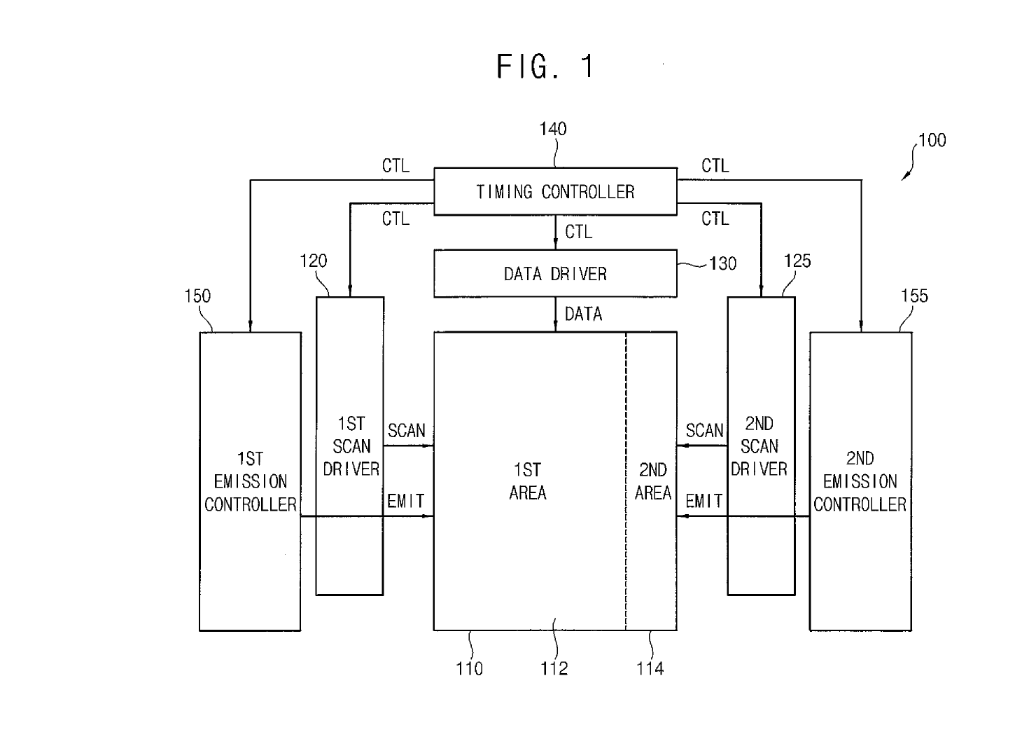

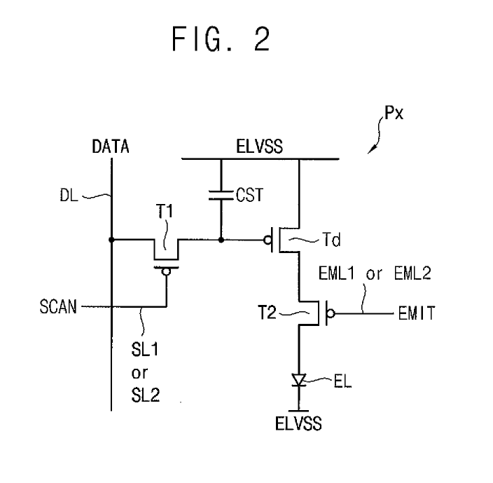

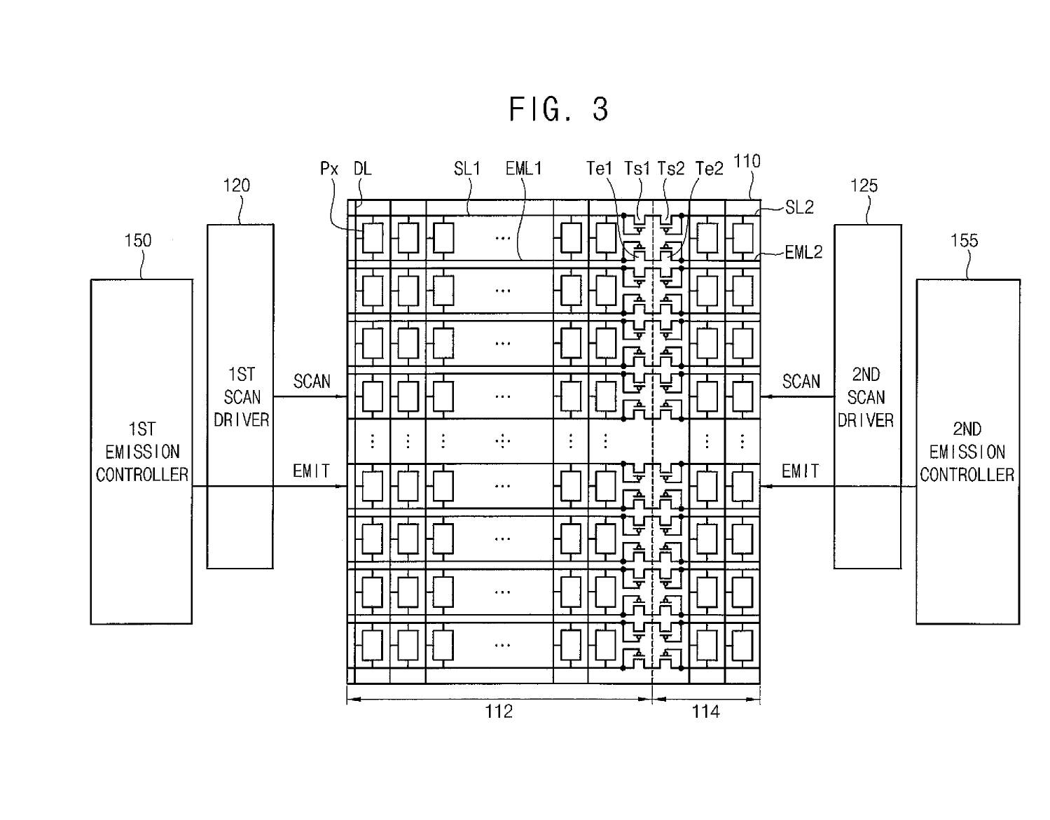

FIG. 1 is a block diagram illustrating a display device according to example embodiments. FIG. 2 is a diagram illustrating an example embodiment of a pixel included in a display panel of the display device of FIG. 1. FIG. 3 is a diagram illustrating a display panel included in the display device of FIG. 1.

Referring to FIGS. 1 through 3, a display device 100 may include a display panel 110, a first scan driver 120, a second scan driver 125, a data driver 130, a timing controller 140, a first emission controller 150, and a second emission controller 155.

The display panel 110 may include a plurality of pixels Px. The pixel Px may include a driving transistor Td, a switching transistor T1, a storage capacitor CST, an emission transistor T2, and an organic light emitting diode EL as shown in FIG. 2. The switching transistor T1 may turn on or turn off in response to a scan signal SCAN provided through corresponding ones of first scan lines SL1 or second scan lines SL2. When the scan signal SCAN having a low level is provided to a gate terminal of the switching transistor T1, the switching transistor T1 may turn on. The switching transistor T1 that is turned on may transfer a data signal DATA provided through a corresponding one of data lines DL to the storage capacitor CST. The storage capacitor CST may store the data signal DATA provided in response to the scan signal SCAN. The driving transistor Td may generate a driving current based on the data signal DATA. The emission transistor T2 may turn on or turn off in response to an emission control signal EMIT provided through corresponding ones of first emission control lines EML1 or second emission control lines EML2. When the emission control signal EMIT having a low level is provided to a gate terminal of the emission transistor T2, the emission transistor T2 may turn on. The driving current may be provided to the organic light emitting diode EL through the emission transistor T2 that is turned on. The pixel Px may further include an initialization transistor that may provide an initialization voltage for initializing a gate terminal of the driving transistor Td, although the initialization transistor has been omitted from FIG. 2. The initialization transistor may turn on in response to the initialization signal provided through a corresponding one of initialization signal lines. The initialization voltage may be provided to the gate terminal of the driving transistor Td through the initialization transistor. Thus, the driving transistor Td may be initialized.

Further, although the driving transistor Td, the switching transistor T1, and the emission transistor T2 implemented as P-channel Metal Oxide Semiconductor (PMOS) are shown in FIG. 2, the transistors are not limited thereto. For example, the driving transistor Td, the switching transistor T1, and the emission transistor T2 may be implemented as N-channel Metal Oxide Semiconductor (NMOS). In this case, the switching transistor T1 may turn on in response to the scan signal SCAN having a high level. Further, the emission transistor T2 may turn on in response to the emission control signal EMIT having a high level.

The display panel 110 may be divided into a first area 112 and a second area 114 as shown in FIG. 3. An image may be displayed on at least one of the first area 112 and the second area 114 based on a driving mode. Further, the image may be displayed on the first area 112 and the second area 114 based on the driving mode. For example, a mobile phone that includes a curved display panel may display the image on a curved area. Here, power consumption may decrease by not providing the scan signal SCAN to the area on which the image is not displayed.

A plurality of data lines DL, first scan lines SL1, second scan lines SL2, first emission control lines EML1, and second emission control lines EML2 may be arranged on the display panel 110. The pixels Px may be arranged at crossing regions (or crossing areas) of the data lines DL and the first scan lines SL1. Further, the pixels Px may be arranged at crossing regions (or crossing areas) of the data lines DL and the second scan lines SL2.

A first scan switching transistor Ts1 and a second scan switching transistor Ts2 may be formed between the first scan line SL1 and the second scan line SL2. The first scan switching transistor Ts1 and the second scan switching transistor Ts2 may be utilized to couple or decouple the first scan line SL1 and the second scan line SL2 based on the scan signal SCAN. The first scan switching transistor Ts1 may include a first terminal coupled to the first scan line SL1, a second terminal coupled to the second scan switching transistor Ts2, and a gate terminal coupled to the first terminal. The second scan switching transistor Ts2 may include a first terminal coupled to the second scan line SL2, a second terminal coupled to the first scan switching transistor Ts1, and a gate terminal coupled to the first terminal. In some example embodiments, the first scan switching transistor Ts1 and the second scan switching transistor Ts2 may be implemented as PMOS transistors. When implemented as PMOS transistors, the first scan switching transistor Ts1 and the second scan switching transistor Ts2 may be turned on in response to the scan signal SCAN having a low level. In other example embodiments, the first scan switching transistor Ts1 and the second scan switching transistor Ts2 may be implemented as NMOS transistors. When implemented as NMOS transistors, the first scan switching transistor Ts1 and the second scan switching transistor Ts2 may be turned on in response to the scan signal SCAN having a high level.

The first scan driver 120 may be arranged at one side (e.g., a left side) of the display panel 110. The second scan driver 125 may be arranged at another side (e.g., a right side) of the display panel 110. The first scan driver 120 may be adjacent to the first area 112. The second scan driver 125 may be adjacent to the second area 114. The first scan driver 120 may provide the scan signals SCAN to the pixels Px through the first scan lines SL1. The second scan driver 125 may provide the scan signals SCAN to the pixels Px through the second scan lines SL2.

The first scan driver 120 and/or the second scan driver 125 may selectively provide the scan signals SCAN through the first scan lines SL1 or the second scan lines SL2 based on the driving mode of the display device 100. The first scan driver 120 may provide the scan signals SCAN to the pixels Px in the first area 112 through the first scan lines SL1 when an image is to be displayed on the first area 112 of the display panel 110. For example, the first scan switching transistor Ts1 may be turned on and the second scan switching transistor Ts2 may be turned off. Thus, the data signals DATA may be stored in the pixels Px in the first area 112. The second scan driver 125 may provide the scan signals SCAN to the pixels Px in the second area 114 through the second scan lines SL2 when an image is to be displayed on the second area 114 of the display panel 110. For example, the first scan switching transistor Ts1 may be turned off and the second scan switching transistor Ts2 may be turned on. Thus, the data signals DATA may be stored in the pixels Px in the second area 114. As described above, when the image is selectively displayed on one of the first area 112 and the second area 114 (e.g., the image is displayed on one of the first area 112 and the second area 114, but not on the other one of the first area 112 and the second area 114), the first scan switching transistor Ts1 or the second scan switching transistor Ts2 may be turned off. Thus, power consumption of the display device 100 may decrease by not providing the scan signal SCAN to the area on which the image is not displayed.

The first scan driver 120 and the second scan driver 125 may provide the scan signals SCAN to the pixels Px in the first area 112 and the second area 114 when an image is displayed on the first area 112 and the second area 114 based on the driving mode. For example, the scan signals SCAN may be provided to the first scan switching transistors Ts1 through the first scan lines SL1 and to the second scan switching transistors Ts2 through the second scan lines SL2. The first scan switching transistors Ts1 and the second scan switching transistors Ts2 may be turned on. Thus, the first scan lines SL1 and the second scan lines SL2 may be coupled to each other. The data signals DATA may be stored in the pixels Px in the first area 112 and the second area 114. As described above, when an image is displayed on the first area 112 and the second area 114, the first scan lines SL1 and the second scan lines SL2 may be coupled to each other by turning on the first scan switching transistors Ts1 and the second scan switching transistors Ts2. Thus, the scan signals SCAN may be stably provided to the pixels Px on the display panel 110.

The data driver 130 may provide the data signals DATA to the pixels Px through the data lines DL. The data driver 130 may not provide the data signals DATA to the area on which the image is not displayed, when the image is displayed on one of the first area 112 or the second area 114. Further, the data driver 130 may provide the data signals DATA that displays black color to the area on which the image is not displayed, when the image is displayed on one of the first area 112 or the second area 114.

The first emission switching transistor Te1 and the second emission switching transistor Te2 may be formed between the first emission control lines EML1 and the second emission control lines EML2. The first emission switching transistor Te1 and the second emission switching transistor Te2 may be utilized to couple or decouple the first emission line EML1 and the second emission line EML2 based on the emission control signal EMIT. The first emission switching transistor Te1 may include a first terminal coupled to the first emission line EML1, a second terminal coupled to the second emission switching transistor Te2, and a gate terminal coupled to the first terminal. The second emission switching transistor Te2 may include a first terminal coupled to the second emission line EML2, a second terminal coupled to the first emission switching transistor Te1, and a gate terminal coupled to the first terminal. In some example embodiments, the first emission switching transistor Te1 and the second emission switching transistor Te2 may be implemented as PMOS transistors. When implemented as PMOS transistors, the first emission switching transistor Te1 and the second emission switching transistor Te2 may be turned on in response to the emission control signal EMIT having a low level. In other example embodiments, the first emission switching transistor Te1 and the second emission switching transistor Te2 may be implemented as NMOS transistors. When implemented as NMOS transistors, the first emission switching transistor Te1 and the second emission switching transistor Te2 may be turned on in response to the emission control signal EMIT having a high level.

The first emission controller 150 may be arranged at one side (e.g., a left side) of the display panel 110. The second emission controller 155 may be arranged at another side (e.g., a right side) of the display panel 110. The first emission controller 150 may be adjacent to the first area 112. The second emission controller 155 may be adjacent to the second area 114. The first emission controller 150 may provide the emission control signals EMIT to the pixels Px through the first emission control lines EML1. The second emission controller 155 may provide the emission control signals EMIT to the pixels Px through the second emission control lines EML2.

The first emission controller 150 and/or the second emission controller 155 may selectively provide the emission control signals EMIT through the first emission control lines EML1 or the second emission control lines EML2 based on the driving mode of the display device 100. The first emission controller 150 may provide the emission control signals EMIT to the pixels Px in the first area 112 through the first emission control lines EML1, when an image is to be displayed on the first area 112 of the display panel 110. For example, the first emission switching transistor Te1 may be turned on and the second emission switching transistor Te2 may be turned off. Thus, the pixels Px in the first area 112 may emit light in response to the emission control signals EMIT. The second emission controller 155 may provide the emission control signals EMIT to the pixels Px in the second area 114 through the second emission control lines EML2, when an image is to be displayed on the second area 114 of the display panel 110. For example, the first emission switching transistor Te1 may be turned off and the second emission switching transistor Te2 may be turned on. Thus, the pixels Px in the second area 114 may emit light in response to the emission control signals EMIT. As described above, when the image is selectively displayed on one of the first area 112 and the second area 114 (e.g., the image is displayed on one of the first area 112 and the second area 114, but not on the other one of the first area 112 and the second area 114), the first emission switching transistor Te1 or the second emission switching transistor Te2 may be turned off. Thus, power consumption of the display device 100 may decrease by not providing the emission control signals EMIT to the area on which the image is not displayed.

The first emission controller 150 and the second emission controller 155 may provide the emission control signals EMIT to the pixels in the first area 112 and the second area 114, when an image is displayed on the first area 112 and the second area 114 based on the driving mode. For example, the emission control signals EMIT may be provided to the first emission switching transistors Te1 through the first emission control lines EML1 and to the second emission switching transistors Te2 through the second emission control lines EML2. The first emission switching transistors Te1 and the second emission switching transistors Te2 may be turned on. Thus, the first emission control lines EML1 and the second emission control lines EML2 may be coupled to each other. The pixels in the first area 112 and the second area 114 may emit light in response to the emission control signals EMIT. As described, when the image is displayed on the first area 112 and the second area, the first emission control lines EML1 and the second emission control lines EML2 may be coupled to each other by turning on the first emission switching transistors Te1 and the second emission switching transistors Te 2. Thus, the emission control signals EMIT may be stably provided to the pixels Px on the display panel 110.

The timing controller 140 may generate control signals that control the first scan driver 120, the second scan driver 125, the first emission controller 150, the second emission controller 155, and the data driver 130.

Although the display device 100 that include the display panel 110, the first scan driver 120, the second scan driver 125, the first emission controller 150, the second emission controller 155, the data driver 130, and the timing controller 140 is described, the display device 100 is not limited thereto. For example, the display device 100 may further include a first initialization driver and a second initialization driver to provide initialization signals to the pixels Px in the first area 112 and the second area 114. For example, first initialization signal lines through which the initialization signals are provided to the pixels Px in the first area 112, second initialization signal lines through which the initialization signals are provided to the pixels Px in the second area 114, and first initialization switching transistors and second initialization switching transistors that are utilized to couple or decouple the first initialization lines and the second initialization lines may be formed on the display panel 110. An operation of the first initialization switching transistor and the second initialization switching transistor may be the same or substantially the same as the operation of the first scan switching transistor Ts1 and the second scan switching transistor Ts2.

As described above, the display device 100 of FIG. 1 may selectively drive one of the first scan driver 120 or the second scan driver 125 coupled to the area on which an image is displayed by disconnecting the first scan lines SL1 and the second scan lines SL2 from each other, when the image is displayed on one of the first area 112 or the second area 114 (e.g., the image is displayed on one of the first area 112 and the second area 114, but not on the other one of the first area 112 and the second area 114). Thus, power consumption may decrease. Further, the display device 100 of FIG. 1 may drive the first scan driver 120 and the second scan driver 125 by coupling the first scan lines SL1 and the second scan lines SL2 to each other, when the image is displayed on the first area 112 and the second area 114. Thus, the scan signal SCAN may be stably provided to the pixels Px.

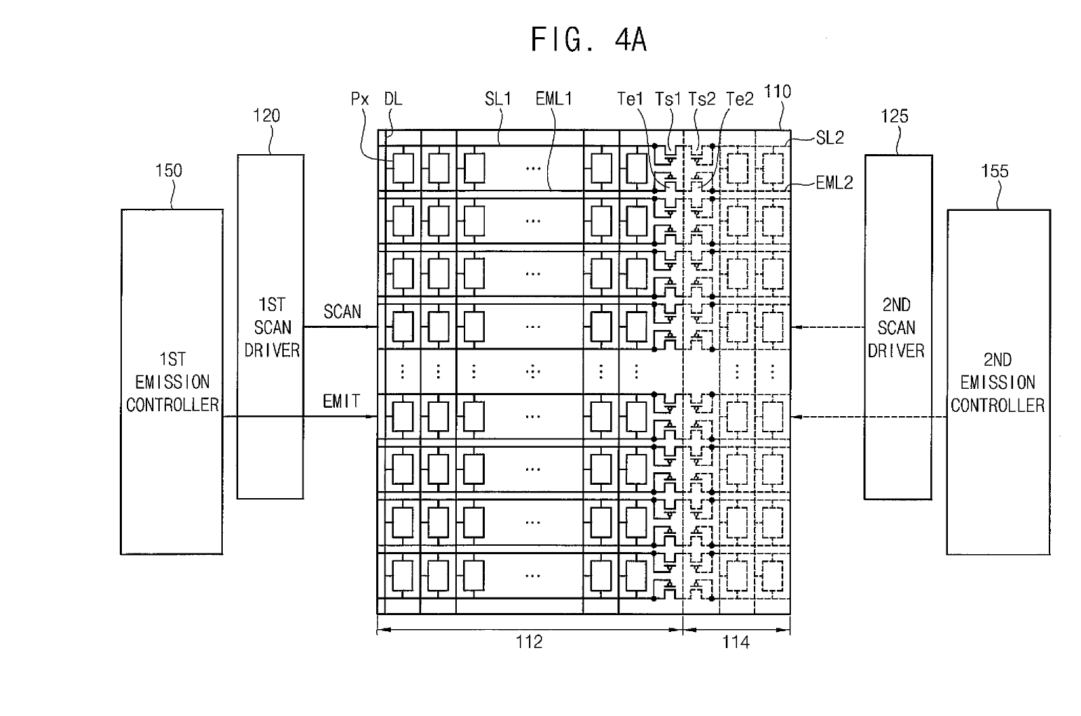

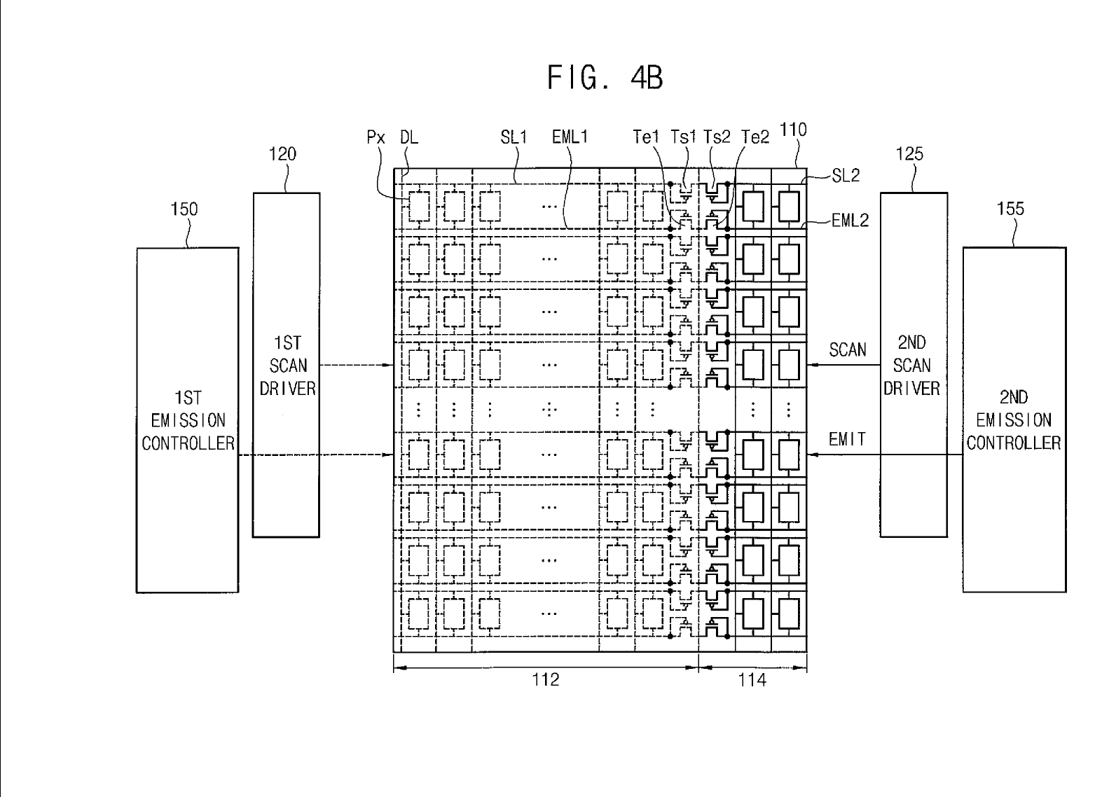

FIGS. 4A and 4B are diagrams illustrating an operation of the display device of FIG. 1.

Referring to FIG. 4A, the first scan driver 120 may provide the scan signal SCAN to the first area 112 of the display panel 110 when the image is displayed on the first area 112 of the display panel 110. Further, the first emission controller 150 may provide the emission control signal EMIT to the first area 112 of the display panel 110 when the image is displayed on only the first area 112 of the display panel 110. The first scan switching transistor Ts1 may be turned on when the scan signal SCAN is provided to the first area 112 through the first scan lines SL1. The first emission switching transistor Te1 may be turned on when the emission control signal EMIT is provided to the first area 112 through the first emission control lines EML1. The second scan driver 125 may not provide the scan signal SCAN to the second area 114 of the display panel 110. The second emission controller 155 may not provide the emission control signal EMIT to the second area 114 of the display panel 110. Thus, the second scan switching transistor Ts2 and the second emission switching transistor Te2 may be turned off. The pixels Px in the first area 112 may store the data signals in the storage capacitors in response to the scan signals SCAN, and may emit light in response to the emission control signals EMIT.

The data driver 130 (see FIG. 1) may provide the data signals to the pixels in the first area 112 through the data lines DL in the first area 112. Here, the data signals may not be provided to the data lines DL in the second area 114. Alternatively, the data signals to display a black color may be provided to the data lines DL in the second area 114. As described above, when the image is displayed on only the first area 112 of the display panel 110 (e.g., the image is displayed on the first area 112, but not on the second area 114), the scan signals SCAN and the emission control signals EMIT may not be provided to the pixels Px in the second area 114 of the display panel 110. Thus, power consumption of the display panel 110 may decrease.

Referring to FIG. 4B, the second scan driver 125 may provide the scan signal SCAN to the second area 114 of the display panel 110 when the image is displayed on only the second area 114 of the display panel 110. Further, the second emission controller 155 may provide the emission control signal EMIT to the second area 114 of the display panel 110 when the image is displayed on only the second area 114 of the display panel 110. The second scan switching transistor Ts2 may be turned on when the scan signal SCAN is provided to the second area 114 through the second scan lines SL2. The second emission switching transistor Te2 may be turned on when the emission control signal EMIT is provided to the second area 114 through the second emission control lines EML2. The first scan driver 120 may not provide the scan signal SCAN to the first area 112 of the display panel 110. The first emission controller 150 may not provide the emission control signal EMIT to the first area 112 of the display panel 110. Thus, the first scan switching transistor Ts1 and the first emission switching transistor Te1 may be turned off. The pixels Px in the second area 114 may store the data signals in the storage capacitors in response to the scan signals SCAN, and may emit light in response to the emission control signals EMIT.

The data driver 130 (see FIG. 1) may provide the data signals to the pixels in the second area 114 through the data lines DL in the second area 114. Here, the data signals may not be provided to the data lines in the first area 112. Alternatively, the data signals to display a black color may be provided to the data lines DL in the first area 112. As described above, when the image is displayed on only the second area 114 of the display panel 110 (e.g., the image is displayed on the second area 114 of the display panel, but not on the first area 112), the scan signal SCAN and the emission control signal EMIT may not be provided to the pixels Px in the first area 112 of the display panel 110. Thus, power consumption of the display panel 110 may decrease.

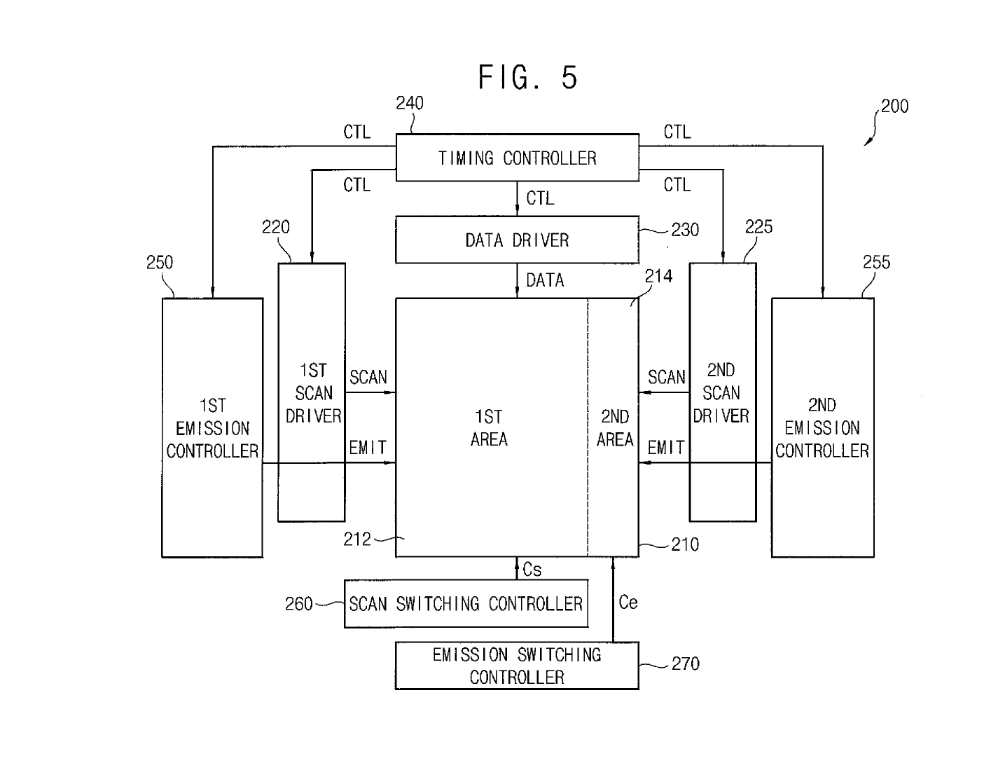

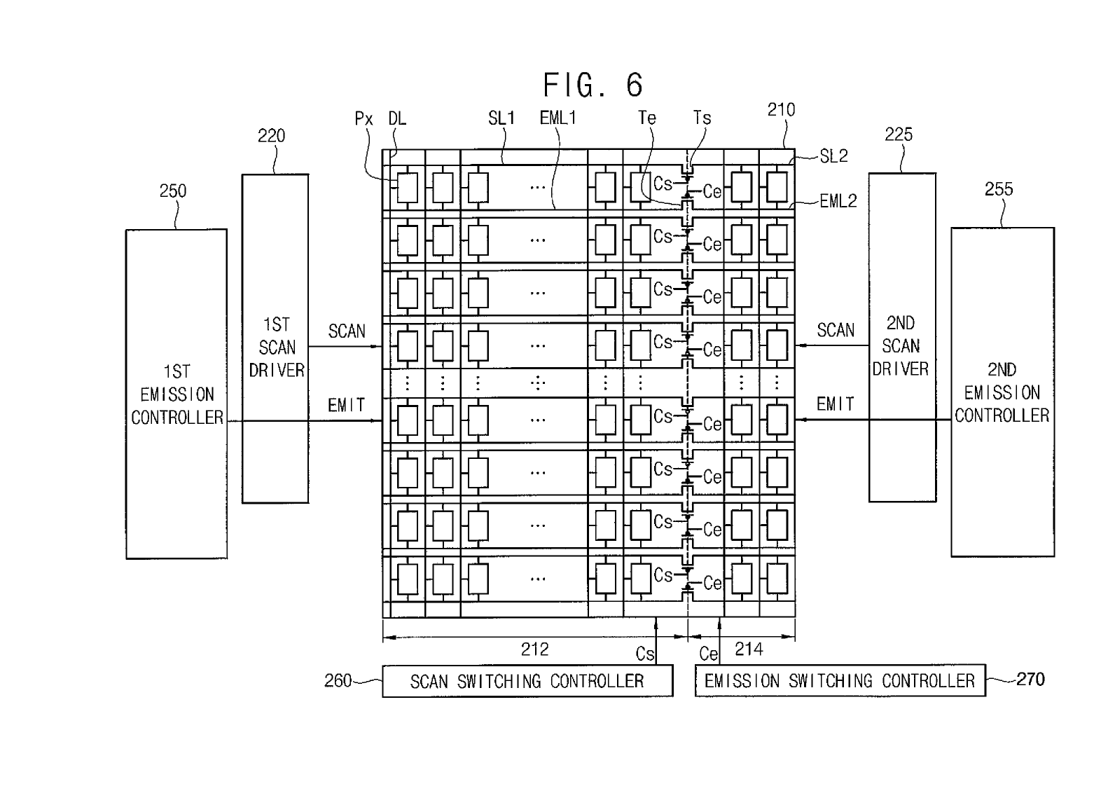

FIG. 5 is a block diagram illustrating a display device according to some example embodiments. FIG. 6 is a diagram illustrating a display panel included in the display device of FIG. 5.

Referring to FIGS. 5 and 6, the display device 200 may include a display panel 210, a first scan driver 220, a second scan driver 225, a scan switching controller 260, a data driver 230, a timing controller 240, a first emission controller 250, a second emission controller 255, and an emission switching controller 270.

The display panel 210 may include a plurality of pixels Px. For example, each of the pixels Px may include a driving transistor, a switching transistor, a storage capacitor, an emission transistor, and an organic light emitting diode as described in FIG. 2.

The display panel 210 may be divided into a first area 212 and a second area 214. An image may be displayed on one of the first area 212 or the second area 214 based on a driving mode. Further, an image may be displayed on the first area 212 and the second area 214 based on the driving mode. For example, the mobile phone that includes a curved display panel may display the image on a curved area. Here, power consumption may decrease by not providing the scan signal SCAN to the area on which the image is not displayed.

Referring to FIG. 6, a plurality of data lines DL, first scan lines SL1, second scan lines SL2, first emission control lines EML1, and second emission control lines EML2 may be arranged on the display panel 210. The pixels Px may be arranged at crossing regions (or crossing areas) of the data lines DL and the first scan lines SL1. Further, the pixels Px may be arranged at crossing regions (or crossing areas) of the data lines DL and the second scan lines SL2.

The scan switching transistor Ts may be formed between the first scan lines SL1 and the second scan lines SL2. The scan switching transistor Ts may be utilized to couple or decouple the first scan lines SL1 and the second scan lines SL2 based on a scan switching signal Cs. The scan switching transistor Ts may include a first terminal coupled to the first scan line SL1, a second terminal coupled to the second scan line SL2, and a gate terminal coupled to the scan switching controller 260. In some example embodiments, the scan switching transistor Ts may be implemented as a PMOS transistor. When implemented as a PMOS transistor, the scan switching transistor Ts may be turned on in response to the scan switching signal Cs having a low level. In other example embodiments, the scan switching transistor Ts may be implemented as an NMOS transistor. When implemented as an NMOS transistor, the scan switching transistor Ts may be turned on in response to the scan switching signal Cs having a high level.

The scan switching controller 260 may generate the scan switching signal Cs to control the scan switching transistor Ts. The scan switching controller 260 may provide the scan switching signal Cs having a high level or a low level to the gate terminal of the scan switching transistor Ts, based on a driving mode of the display device 200. The scan switching controller 260 may provide the scan switching signal Cs to turn off the scan switching transistor Ts, when the image is displayed on one of the first area 212 or the second area 214 (e.g., the image is displayed on one of the first area 212 and the second area 214, but not on the other one of the first area 212 and the second area 214). The scan switching controller 260 may provide the scan switching signal Cs to turn on the scan switching transistor Ts, when the image is displayed on the first area 212 and the second area 214.

The first scan driver 220 may be arranged at one side (e.g., a left side) of the display panel 210. The second scan driver 225 may be arranged at another side (e.g., a right side) of the display panel 210. The first scan driver 220 may be adjacent to the first area 212. The second scan driver 225 may be adjacent to the second area 214. The first scan driver 220 may provide the scan signal SCAN to the pixels Px through the first scan lines SL1. The second scan driver 225 may provide the scan signal SCAN to the pixels Px through the second scan lines SL2.

The first scan driver 220 or the second scan driver 225 may selectively provide the scan signal SCAN through the first scan lines SL1 or the second scan lines SL2 based on the driving mode of the display device 200. The first scan driver 220 may provide the scan signals SCAN to the pixels Px in the first area 212 through the first scan lines SL1, when the image is displayed on only the first area 212 of the display panel 210. For example, the scan switching controller 260 may provide the scan switching signal Cs to turn off the scan switching transistor Ts. The scan signal SCAN may not be provided to the second area 214. Thus, the data signals DATA may be stored in the pixels in the first area 212. The second scan driver 225 may provide the scan signals SCAN to the pixels Px in the second area 214 through the second scan lines SL2, when the image is displayed on only the second area 214 of the display panel 210. For example, the scan switching controller 260 may provide the scan switching signal Cs to turn off the scan switching transistor Ts. The scan signal SCAN may not be provided to the first area 212. Thus, the data signals DATA may be stored in the pixels in the second area 214. As described above, when the image is selectively displayed on one of the first area 212 and the second area 214 (e.g., the image is displayed on one of the first area 212 and the second area 214, but not on the other one of the first area 212 and the second area 214), the scan switching transistor Ts may be turned off. Thus, power consumption of the display device 200 may decrease by not providing the scan signal SCAN to the area on which the image is not displayed.

The first scan driver 220 and the second scan driver 225 may provide the scan signals SCAN to the pixels in the first area 212 and the second area 214, when the image is displayed on the first area 212 and the second area 214 based on the driving mode. For example, the scan switching controller 260 may provide the scan switching signal Cs to turn on the scan switching transistor Ts. Thus, the first scan lines SL1 and the second scan lines SL2 may be coupled to each other. The data signals DATA may be stored in the pixels Px in the first area 212 and the second area 214. As described above, when the image is displayed on the first area 212 and the second area 214, the first scan lines SL1 and the second scan lines SL2 may be coupled to each other by turning on the scan switching transistors Ts. Thus, the scan signals SCAN may be stably provided to the pixels Px on the display panel 210.

The data driver 230 may provide the data signals DATA to the pixels Px through the data lines DL. The data driver 230 may not provide the data signals DATA to the area on which the image is not displayed, when the image is displayed on one of the first area 212 or the second area 214 (e.g., the image is displayed on one of the first area 212 and the second area 214, but not on the other one of the first area 212 and the second area 214). Alternatively, the data driver 230 may provide the data signals DATA to display black color to the area on which the image is not displayed, when the image is displayed on one of the first area 212 or the second area 214.

The emission switching transistor Te may be formed between the first emission control lines EML1 and the second emission control lines EML2. The emission switching transistor Te may be utilized to couple or decouple the first emission control lines EML1 and the second emission control lines EML2 based on an emission switching signal Ce. The emission switching transistor Te may include a first terminal coupled to the first emission control line EML1, a second terminal coupled to the second emission control line EML2, and a gate terminal coupled to the emission switching controller 270. In some example embodiments, the emission switching transistor Te may be implemented as a PMOS transistor. When implemented as a PMOS transistor, the emission switching transistor Te may be turned on in response to the emission switching signal Ce having a low level. In other example embodiments, the emission switching transistor Te may be implemented as an NMOS transistor. When implemented as an NMOS transistor, the emission switching transistor Te may be turned on in response to the emission switching signal Ce having a high level.

The emission switching controller 270 may generate the emission switching signal Ce to control the emission switching transistor Te. The emission switching controller 270 may provide the emission switching signal Ce having a high level or a low level to the gate terminal of the emission switching transistor Te based on the driving mode of the display device 200. The emission switching controller 270 may provide the emission switching signal Ce to turn off the emission switching transistor Te, when the image is displayed on one of the first area 212 or the second area 214 (e.g., the image is displayed on one of the first area 212 and the second area 214, but not on the other one of the first area 212 and the second area 214). The emission controller 270 may provide the emission switching signal Ce to turn on the emission switching transistor Te, when the image is displayed on the first area 212 and the second area 214.

The first emission controller 250 may be arranged at one side (e.g., a left side) of the display panel 210. The second emission controller 255 may be arranged at another side (e.g., a right side) of the display panel 210. The first emission controller 250 may be adjacent to the first area 212. The second emission controller 255 may be adjacent to the second area 214. The first emission controller 250 may provide the emission control signals EMIT to the pixels Px through the first emission control lines EML1. The second emission controller 255 may provide the emission control signals EMIT to the pixels Px through the second emission control lines EML2.

The first emission controller 250 or the second emission controller 255 may selectively provide the emission control signals EMIT through the first emission control line EML1 or the second emission control line EML2 based on the driving mode of the display device 200. The first emission controller 250 may provide the emission control signals EMIT to the pixels Px in the first area 212 through the first emission control lines EML1, when the image is displayed on only the first area 212 of the display panel 210. For example, the emission switching controller 270 may provide the emission switching signal Ce to turn off the emission switching transistor Te. The emission control signal EMIT may not be provided to the second area 214. Thus, the pixels Px in the first area 212 may emit light in response to the emission control signals EMIT. The second emission controller 255 may provide the emission control signals EMIT to the pixels Px in the second area 214 through the second emission control lines EML2, when the image is displayed on only the second area 214 of the display panel 210. For example, the emission switching controller 270 may provide the emission switching signal Ce to turn off the emission switching transistor Te. The emission control signal EMIT may not be provided to the first area 212. Thus, the pixels Px in the second area 214 may emit light in response to the emission control signals EMIT. As described above, when the image is selectively displayed on one of the first area 212 and the second area 214 (e.g., the image is displayed on one of the first area 212 and the second area 214, but not on the other one of the first area 212 and the second area 214), the emission switching transistor Te may be turned off. Thus, power consumption of the display device 200 may decrease by not providing the emission control signal EMIT to the area on which the image is not displayed.

The first emission controller 250 and the second emission controller 255 may provide the emission control signals EMIT to the pixels in the first area 212 and the second area 214 when the image is displayed on the first area 212 and the second area 214 based on the driving mode. For example, the emission switching controller 270 may provide the emission switching signal Ce to turn on the emission switching transistor Te. Thus, the first emission control lines EML1 and the second emission control lines EML2 may be coupled to each other. The pixels Px in the first area 212 and the second area 214 may emit light in response to the emission control signals EMIT. As described above, when the image is displayed on the first area 212 and the second area 214, the first emission control lines EML1 and the second emission control lines EML2 may be coupled to each other by turning on the emission switching transistors Te. Thus, the emission control signals EMIT may be stably provided to the pixels Px on the display panel 210.

The timing controller 240 (see FIG. 5) may generate control signals CTL to control the first scan driver 220, the second scan driver 225, the first emission controller 250, the second emission controller 255, and the data driver 230.

Although the display device 200 that includes the display panel 210, the first scan driver 220, the second scan driver 225, the first emission controller 250, the second emission controller 255, the scan switching controller 260, the emission switching controller 270, the data driver 230, and the timing controller 240 is described, the display device 200 is not limited thereto. For example, the display device 200 may further include a first initialization driver and a second initialization driver to provide an initialization signal to the pixels Px in the first area 212 and the second area 214. Here, first initialization signal lines through which the initialization signal is provided to the pixels Px in the first area 212, second initialization signal lines through which the initialization signal is provided to the pixels Px in the second area 214, and initialization switching transistors that may be utilized to couple or decouple the first initialization lines and the second initialization lines may be formed on the display panel 210. Further, the display device 210 may further include an initialization switching controller to control the initial switching transistors. An operation of the initialization switching transistors and the initialization switching controller may be same or substantially the same as the operation of the scan switching transistors Ts and the scan switching controller 260.

As described above, the display device 200 of FIG. 6 may selectively drive one of the first scan driver 220 or the second scan driver 225 coupled to the area on which the image is displayed by disconnecting the first scan lines SL1 and the second scan lines SL2 from each other, when the image is displayed on one of the first area 212 or the second area 214 (e.g., the image is displayed on one of the first area 212 and the second area 214, but not on the other one of the first area 212 and the second area 214). Thus, power consumption may decrease. Further, the display device 200 of FIG. 6 may drive the first scan driver 220 and the second scan driver 225 by coupling the first scan lines SL1 and the second scan lines SL2 to each other, when the image is displayed on the first area 212 and the second area 214. Thus, the scan signals SCAN may be stably provided to the pixels Px.

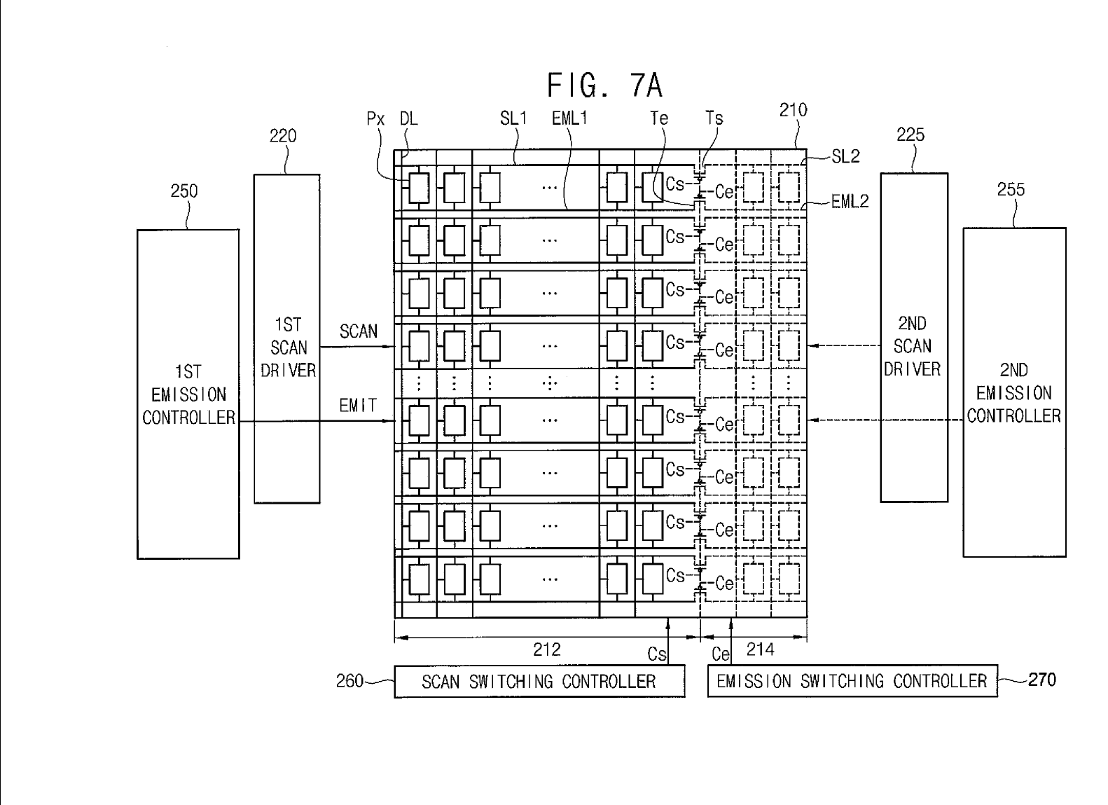

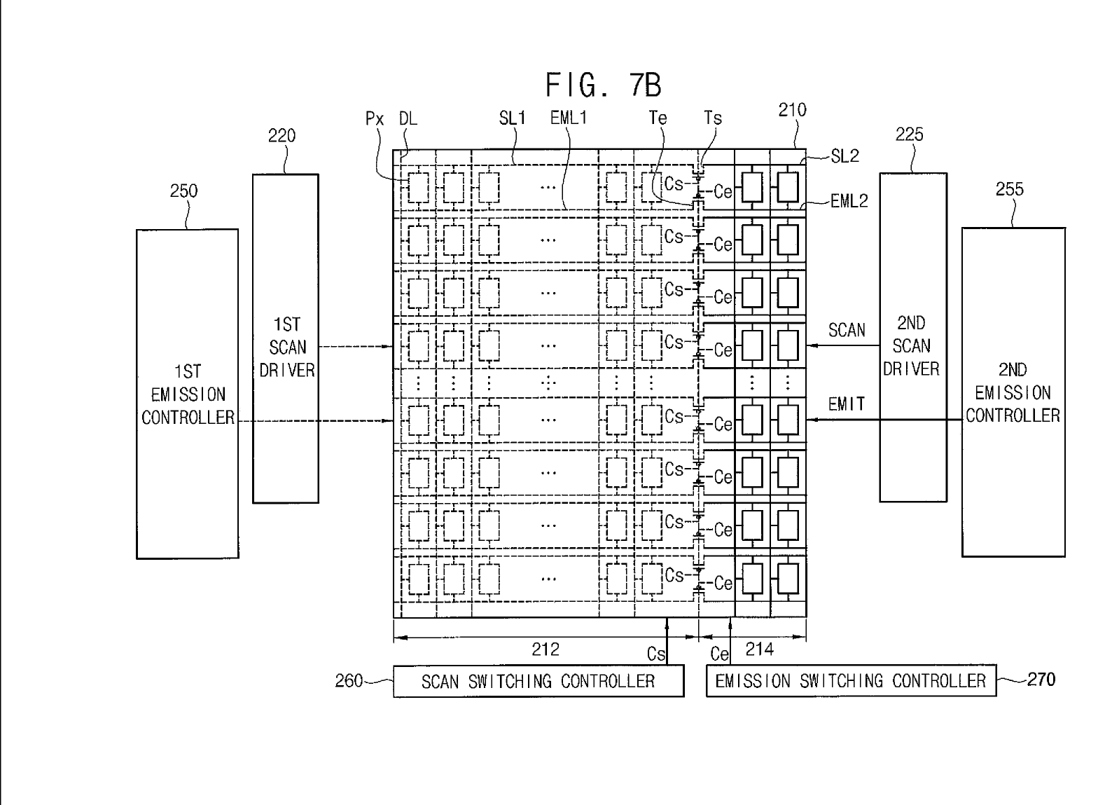

FIGS. 7A and 7B are diagrams illustrating an operation of the display device of FIG. 5.

Referring to FIG. 7A, the first scan driver 220 may provide the scan signal SCAN to the first area 212 of the display panel 210, when the image is displayed on only the first area 212 of the display panel 210. Further, the first emission controller 250 may provide the emission control signal EMIT to the first area 212 of the display panel 210, when the image is displayed on only the first area 212 of the display panel 210. Here, the scan switching controller 260 may provide the scan switching signal Cs to turn off the scan switching transistor Ts. The emission switching controller 270 may provide the emission switching signal Ce to turn off the emission switching transistor Te. When the scan switching transistor Ts is turned off, the scan signal SCAN provided from the first scan driver 220 may not be provided to the pixels Px in the second area 214. When the emission switching transistor Te is turned off, the emission control signal EMIT provided from the first emission controller 250 may not be provided to the pixels Px in the second area 214. Thus, the pixels Px in the first area 212 may store the data signals in the storage capacitors in response to the scan signals SCAN, and may emit light in response to the emission control signals EMIT.

The data driver may provide the data signals to the pixels in the first area 212 through the data lines DL in the first area 212. Here, the data signals may not be provided to the data lines DL in the second area 214. Alternatively, the data signals to display a black color may be provided to the data lines DL in the second area 214. As described above, when the image is displayed on only the first area 212 of the display panel 210 (e.g., but not on the second area 214), the scan signal SCAN and the emission control signal EMIT may not be provided to the second area 214 of the display panel 210. Thus, power consumption of the display panel 210 may decrease.

Referring to FIG. 7B, the second scan driver 225 may provide the scan signal SCAN to the second area 214 of the display panel 210, when the image is displayed on only the second area 214 of the display panel 210. Further, the second emission controller 255 may provide the emission control signal EMIT to the second area 214 of the display panel 210, when the image is displayed on only the second area 214 of the display panel 210. Here, the scan switching controller 260 may provide the scan switching signal Cs to turn off the scan switching transistor Ts. The emission switching controller 270 may provide the emission switching signal Ce to turn off the emission switching transistor Te. When the scan switching transistor Ts is turned off, the scan signal SCAN provided form the second scan driver 225 may not be provided to the pixels in the first area 212. When the emission switching transistor Te is turned off, the emission control signal EMIT provided from the second emission controller 255 may not be provided to the pixels in the first area 212. Thus, the pixels Px in the second area 214 may store the data signals in the storage capacitors in response to the scan signals SCAN, and may emit light in response to the emission control signals EMIT.

The data driver 230 (see FIG. 5) may provide the data signals to the pixels in the second area 214 through the data lines DL in the second area 214. Here, the data signals may not be provided to the data lines DL in the first area 212. Alternatively, the data signals to display a black color may be provided to the data lines DL in the first area 212. As described above, when the image is displayed on only the second area 214 of the display panel 210 (e.g., but not on the first area 212), the scan signal SCAN and the emission control signal EMIT may not be provided to the first area 2142 of the display panel 210. Thus, power consumption of the display panel 210 may decrease.

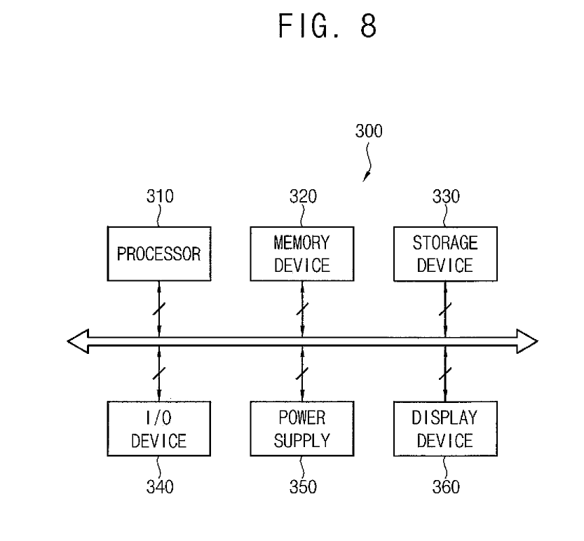

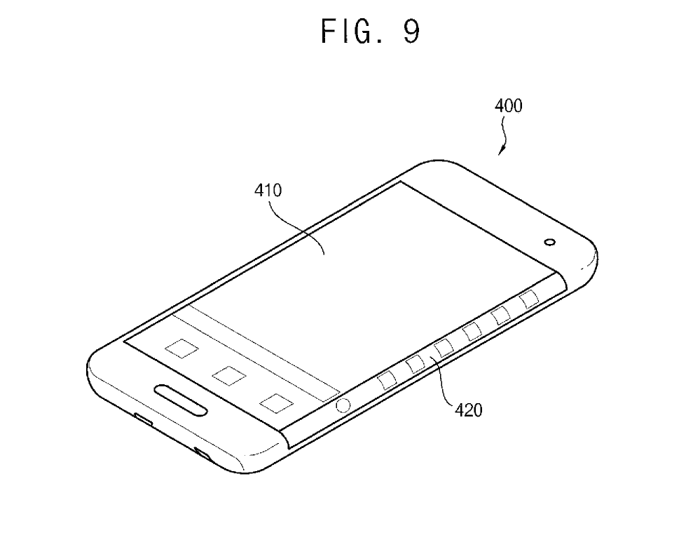

FIG. 8 is a block diagram illustrating an electronic device that includes the display device of FIG. 1 or FIG. 5, and FIG. 9 is a diagram illustrating an example embodiment in which the electronic device of FIG. 8 is implemented as a smart phone.

Referring to FIGS. 8 and 9, the electronic device 300 may include a processor 310, a memory device 320, a storage device 330, an input/output (I/O) device 340, a power supply 350, and a display device 360. Here, the display device 360 may correspond to the display device 100 of FIG. 1 or the display device 200 of FIG. 5. In addition, the electronic device 300 may further include a plurality of ports to communicate with a video card, a sound card, a memory card, a universal serial bus (USB) device, other electronic device, etc. Although it is illustrated in FIG. 9 that the electronic device 300 is implemented as a smart-phone 400, the present invention is not limited thereto.

The processor 310 may perform various computing functions. The processor 310 may be a microprocessor, a central processing unit (CPU), etc. The processor 310 may be coupled to other components via an address bus, a control bus, a data bus, etc. Further, the processor 310 may be coupled to an extended bus, such as a peripheral component interconnect (PCI) bus. The memory device 320 may store data for operations of the electronic device 300. For example, the memory device 320 may include at least one non-volatile memory device, such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc., and/or at least one volatile memory device, such as a dynamic random access memory (DRAM) device, a static random access memory (SRAM) device, a mobile DRAM device, etc. The storage device 330 may be a solid stage drive (SSD) device, a hard disk drive (HDD) device, a CD-ROM device, etc.

The I/O device 340 may include an input device, such as a keyboard, a keypad, a touchpad, a touch-screen, a mouse, etc., and/or an output device, such as a printer, a speaker, etc. In some example embodiments, the display device 360 may be included in the I/O device 340. The power supply 350 may provide power for operations of the electronic device 300. The display device 360 may communicate with other components via the buses or other communication links. As described above, the display device 360 may include a display panel, a first scan driver, a second scan driver, a data driver, and a timing controller. The display panel may be divided into a first area and a second area. An image may be displayed on one of the first area or the second area based on a driving mode of the display device 360 (e.g., the image may be displayed on one of the first area and the second area, but not on the other one of the first area 112 and the second area 114). Further, the image may be displayed on the first area and the second area based on the driving mode of the display device 360. First scan lines may be formed in the first area of the display panel. Second scan lines may be formed in the second area of the display panel. Switching elements that are utilized to couple or decouple the first scan lines and the second scan lines may be arranged between the first scan lines and the second scan lines. In some example embodiments, a first scan switching transistor and a second scan switching transistor may be arranged between the first scan line and the second scan line. The first scan switching transistor may be turned on or turned off in response to a scan signal provided through the first scan line. The second scan switching transistor may be turned on or turned off in response to the scan signal provided through the second scan line. One of the first scan switching transistor or the second scan switching transistor may be turned on by the scan signal provided through the one of the first scan lines or the second scan lines when the image is displayed on one of the first area or the second area. Here, the scan signal may not be provided to the area on which the image is not displayed. Thus, power consumption of the display device 360 may decrease. In other example embodiments, a scan switching transistor may be formed between the first scan line and the second scan line. The scan switching transistor may be turned on or turned off in response to the scan switching signal provided from a scan switching controller. The scan switching transistor may be turned off when the image is displayed on one of the first area or the second area (e.g., the image is displayed on one of the first area and the second area, but not on the other one of the first area and the second area). Here, the scan signal may not be provided to the area on which the image is not displayed. Thus, power consumption of the display device 360 may decrease.

As described above, the display device 360 included in the electronic device 300 may divide the display panel into the first area and second area, may disconnect the first scan lines in the first area and the second scan lines in the second area, and may provide the scan signal to one of the first scan lines or the second scan lines when the image is displayed on one of the first area or the second area (e.g., the image is displayed on one of the first area and the second area, but not on the other one of the first area and the second area). Thus, the power consumption of the electronic device 300 may decrease. Further, the display device 360 included in the electronic device 300 may couple the first scan lines in the first area and the second scan lines in the second area to each other, and may provide the scan signal to the first scan lines and the second scan lines. Thus, the scan signal may be stably provided to the display panel.

The present inventive concept may be applied to a display device and/or an electronic device having the display device. For example, the present inventive concept may be applied to a computer monitor, a laptop, a digital camera, a cellular phone, a smart phone, a smart pad, a television, a personal digital assistant (PDA), a portable multimedia player (PMP), a MP3 player, a navigation system, a game console, a video phone, etc.

In the drawings, the relative sizes of elements, layers, and regions may be exaggerated for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present inventive concept.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present inventive concept. As used herein, the singular forms “a” and “an” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

The foregoing is illustrative of example embodiments and is not to be construed as limiting thereof. Although some example embodiments have been described, those skilled in the art will readily appreciate that various modifications may be possible in the example embodiments, without materially departing from the spirt and scope of the present inventive concept. Accordingly, all such modifications are intended to be included within the scope of the present inventive concept as defined in the claims, and their equivalents. Therefore, it is to be understood that the foregoing is illustrative of various example embodiments, and the inventive concept is not to be construed as limited to the specific example embodiments disclosed, and that various modifications to the disclosed example embodiments, as well as other example embodiments, are intended to be included within the spirt and scope of the appended claims, and their equivalents.

What is claimed is:

1. A display device comprising:
a display panel comprising a plurality of pixels, the display panel being divided into a first area and a second area;
a first scan driver configured to provide a scan signal to a pixel from among the pixels arranged in the first area through a first scan line coupled to the pixel in the first area;
a second scan driver configured to provide the scan signal to a pixel from among the pixels arranged in the second area through a second scan line coupled to the pixel in the second area;
a first scan switching transistor and a second scan switching transistor configured to couple the first scan line to the second scan line based on the scan signal, the first scan switching transistor and the second scan switching transistor being arranged between the first area and the second area;
a data driver configured to provide data signals to the pixels in the first area and the second area through data lines coupled to the pixels in the first area and the second area; and
a timing controller configured to generate control signals to control the first scan driver, the second scan driver, and the data driver.

2. The display device of claim 1, wherein the first scan switching transistor is configured to turn on in response to the scan signal provided from the first scan driver, and the second scan switching transistor is configured to turn off when an image is displayed on only the first area.

3. The display device of claim 1, wherein the second scan switching transistor is configured to turn on in response to the scan signal provided from the second scan driver, and the first scan switching transistor is configured to turn off when an image is displayed on only the second area.

4. The display device of claim 1, wherein the first scan lines and the second scan lines are coupled to each other when the first scan switching transistor and the second scan switching transistor are turned on in response to the scan signal provided from the first scan driver and the second scan driver when an image is displayed on the first area and the second area.

5. The display device of claim 1, wherein the first scan driver is arranged at one side of the display panel, and
wherein the second scan driver is arranged at another side of the display panel.

6. The display device of claim 1, wherein the first scan switching transistor comprises:
a first terminal coupled to the first scan line;
a second terminal coupled to the second switching transistor; and
a gate terminal coupled to the first terminal.

7. The display device of claim 1, wherein the second scan switching transistor comprises:
a first terminal coupled to the second scan line;
a second terminal coupled to the first scan switching transistor; and
a gate terminal coupled to the first terminal.

8. The display device of claim 1, wherein the first scan switching transistor and the second switching transistor comprise a P-channel Metal Oxide Semiconductor (PMOS).

9. The display device of claim 1, wherein the first scan switching transistor and the second switching transistor comprise an N-channel Metal Oxide Semiconductor (NMOS).

10. The display device of claim 1, further comprising:
a first emission controller configured to provide an emission control signal to the pixel in the first area through a first emission control line coupled to the pixel in the first area;
a second emission controller configured to provide the emission control signal to the pixel in the second area through a second emission control line coupled to the pixel in the second area; and
a first emission switching transistor and a second emission switching transistor configured to couple the first emission control line to the second emission control line based on the emission control signal, the first emission switching transistor and the second emission switching transistor being arranged between the first area and the second area.

11. The display device of claim 10, wherein the first emission switching transistor comprises:
a first terminal coupled to the first emission control line;
a second terminal coupled to the second emission switching transistor; and
a gate terminal coupled to the first terminal.

12. The display device of claim 10, wherein the second emission switching transistor comprises:
a first terminal coupled to the second emission line;
a second terminal coupled to the first emission switching transistor; and
a gate terminal coupled to the first terminal.

13. A display device comprising:
a display panel comprising a plurality of pixels, the display panel being divided into a first area and a second area;
a first scan driver configured to provide a scan signal to a pixel from among the pixels arranged in the first area through a first scan line coupled to the pixel in the first area;
a second scan driver configured to provide the scan signal to a pixel from among the pixels arranged in the second area through a second scan line coupled to the pixel in the second area;
a scan switching transistor configured to couple the first scan line to the second scan line, the scan switching transistor being arranged between the first scan line and the second scan line;
a scan switching controller configured to generate a scan switching signal to control the scan switching transistor;
a data driver configured to provide data signals to the pixels in the first area and the second area through data lines coupled to the pixels in the first area and the second area; and
a timing controller configured to generate control signals to control the first scan driver, the second scan driver, and the data driver.

14. The display device of claim 13, wherein the scan switching transistor is configured to turn off in response to the scan switching signal when an image is displayed on only the first area.

15. The display device of claim 13, wherein the scan switching transistor is configured to turn off in response to the scan switching signal when an image is displayed on only the second area.

16. The display device of claim 13, wherein the first scan line and the second scan line are coupled to each other when the scan switching transistor is turned on in response to the scan switching signal when an image is displayed on the first area and the second area.

17. The display device of claim 13, wherein the first scan driver is arranged at one side of the display panel, and
wherein the second scan driver is arranged at another side of the display panel.

18. The display device of claim 13, further comprising:
a first emission controller configured to provide an emission control signal to the pixel in the first area through a first emission control line coupled to the pixel in the first area;
a second emission controller configured to provide the emission control signal to the pixel in the second area through a second emission control line coupled to the pixel in the second area;
an emission switching transistor configured to couple the first emission control line to the second emission control line, the emission switching transistor being arranged between the first area and the second area; and
an emission switching controller configured to generate an emission switching signal to control the emission switching transistor.

19. The display device of claim 18, wherein the emission switching transistor is configured to turn off in response to the emission switching signal when an image is displayed on only the first area or only the second area.

20. The display device of claim 18, wherein the emission switching transistor is configured to turn on in response to the emission switching signal when an image is displayed on the first area and the second area.
